(19) United States
(12) Patent Application Publication
(10) Pub. No.: US 2006/0010118 A1
(43) Pub. Date: Jan. 12, 2006

(54) System and method for role-based spreadsheet data integration

(76) Inventors: Juergen Sattler, Wiesloch (DE); Joachim Gaffga, Wiesloch (DE)

Correspondence Address: KENYON & KENYON, 1500 K. STREET N.W., SUITE 700, WASHINGTON, DC, 20005, US

(21) Appl. No.: 11/177,326

(22) Filed: Jul. 11, 2005

Related U.S. Application Data
(63) Continuation-in-part of application No. 11/026,051, filed on Jan. 3, 2005.
(60) Provisional application No. 60/586,277, filed on Jul. 9, 2004.
(60) Provisional application No. 60/586,233, filed on Jul. 9, 2004.
(60) Provisional application No. 60/586,234, filed on Jul. 9, 2004.
(60) Provisional application No. 60/620,682, filed on Oct. 22, 2004.

(51) Int. Cl. G06F 7/00

(52) U.S. Cl. 707/3

(57) ABSTRACT

A system and method for integrating role-based data into a spreadsheet. According to one embodiment, a server receives a query request from a spreadsheet application on behalf of a user of the spreadsheet application, determines a role assigned to the user, executes a first query associated with the query request and not constrained by the role assigned to the user, executes a second query associated with the query request and constrained by the role assigned to the user, combines results of the first and second executed queries to form a first data set, and provides to the spreadsheet application the first data set in response to the query request.

### CROSS REFERENCE TO RELATED APPLICATIONS

This application claims the benefit under 35 U.S.C. § 119(e) of U.S. Provisional Application No. 60/586,277, filed Jul. 9, 2004. This application also is a continuation-in-part of U.S. patent application Ser. No. 11/026,051, filed Jan. 3, 2005, which claims the benefit under 35 U.S.C. § 119(e) of U.S. Provisional Application Nos. 60/586,233 and 60/586,234, both filed Jul. 9, 2004, and U.S. Provisional Application No. 60/620,682, filed Oct. 22, 2004.

### BACKGROUND OF THE INVENTION

Computer systems are commonly used in business to operate on sets of data, which are generally maintained in databases or spreadsheet data files. Some data sets are organized in rows and columns, while others may comprise a collection of data objects. Examples of application programs that manipulate data sets are Microsoft Excel®, SAP mySAP CRM®, Lotus Domino®, etc.

In order to carry out their assigned tasks, different users or groups of users within an organization often utilize the same data set. For example, one user may create a spreadsheet with data about sales opportunities and save that spreadsheet to a file, and another user or multiple users may later open that file to view the data, and possibly modify or add to the data. In another example, one or more users may make the same query of a database to retrieve and operate on the desired information.

A set of data for access by multiple users may be referred to as common data, or a commonly-used or commonly-available data set. The structure, organization, and management of such data sets are generally defined on the “smallest” common approach that is useful throughout an organization (i.e., the least common denominator). For example, a common data set is generally maintained in a system in such a way that all relevant employees in the company may easily access that data.

However, it is often the case that users may wish to add, delete, or otherwise modify the values in a data set. For example, a user may wish to add a column to a spreadsheet that contains the user's own personal notes adjacent to common data. Such modifications to the original common data set may be referred to as an extension of the data set. Thus, companies, subsidiaries, teams, or individual employees often extend a common data set with additional information, and subsequently exchange this extended data with other colleagues, teams, etc. within the organization.

When users extend a data set, they may either modify the original (master) copy of the data set, in which case the modified data set will replace the original data set in a computer system, or they may make a duplicate copy of the data set and modify the duplicate copy. These two options for extending a data set each have drawbacks. For instance, if a user modifies the original copy of the data set, then the original data will be lost, while all the extensions that have been made will be provided to all other users who have access to the data set, even though that may not be desired. On the other hand, if a user modifies a duplicate copy of the data set, then changes may be later made to the original data set that are not reflected in the modified duplicate copy. Because corporate information processing occurs on the least common denominator of information requirements between headquarters, regional offices, local offices, individuals, etc., many variations of the common data may exist.

Accordingly, the present inventors perceive a need in the art for an integrated work environment that provides for coherent role-based extensions of commonly-available data sets.

### BRIEF DESCRIPTION OF THE DRAWINGS

FIG. 1 is a block diagram that depicts a user computer system and back-end database in accordance with an embodiment of the present invention.

FIG. 2 is a block diagram that depicts representations of a spreadsheet user interface in accordance with an embodiment of the present invention.

FIG. 3 is a block diagram that depicts role-based spreadsheet views of a data set in accordance with an embodiment of the present invention.

FIG. 4 is a block diagram that depicts a system architecture in accordance with an embodiment of the present invention.

FIG. 5 is a process flow diagram that depicts an authentication and query presentation process in accordance with an embodiment of the present invention.

FIG. 6 is a process flow diagram that depicts a query process in accordance with an embodiment of the present invention.

FIG. 7 is a block diagram that depicts generation of a spreadsheet file from back-end system data in accordance with an embodiment of the present invention.

FIG. 8 is a process flow diagram that depicts a refresh process in accordance with an embodiment of the present invention.

FIG. 9 is a process flow diagram that depicts an upload process in accordance with an embodiment of the present invention.

FIG. 10 is a block diagram that depicts a computing device in accordance with an embodiment of the present invention.

### DETAILED DESCRIPTION

The present invention addresses the current drawbacks in known systems by allowing users of a spreadsheet program to extend imported results of a queried external common data set from within the spreadsheet program environment, and to have the extensions associated with the external common data set via role-based permissions.

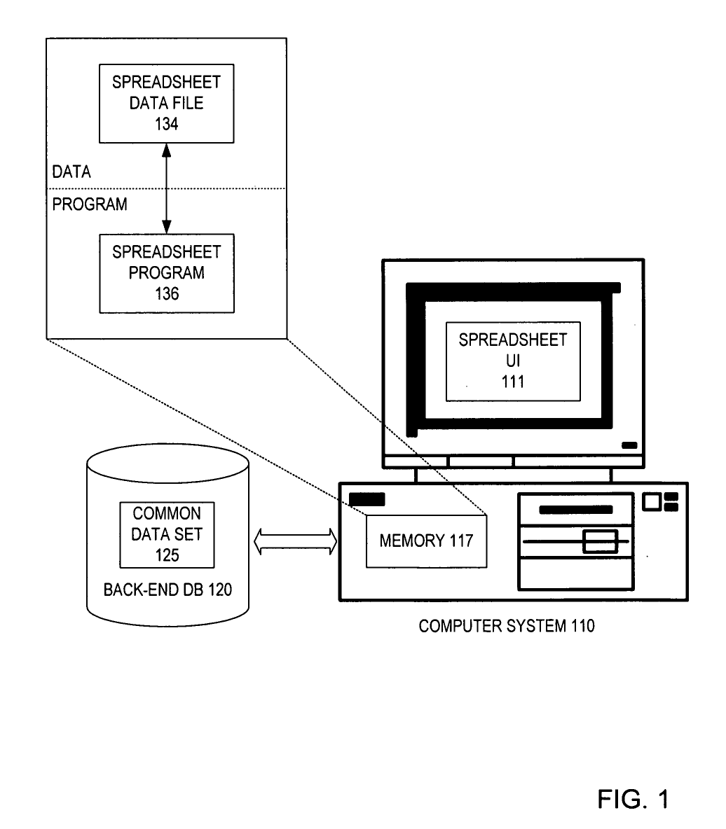

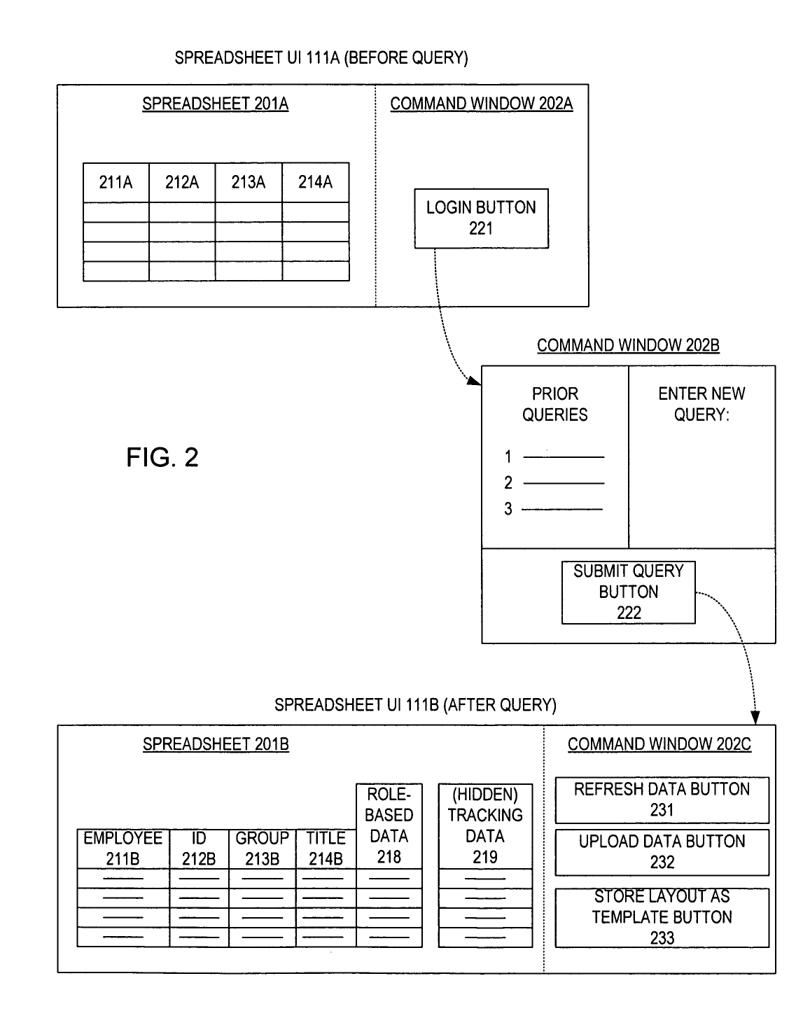

FIGS. 1 and 2 illustrate an embodiment of the present invention in which a user interacts with the user interface (111) of a spreadsheet program (136) on computer system 110 to search, retrieve and operate on data from a common data set (125) in a back-end database (120).

As shown in FIG. 1, the spreadsheet program (136) allows the user, through its user interface (111), to log in and query a common data set (125) in a back-end system, which then generates a spreadsheet data file (134) with the results of the query for display through the spreadsheet user interface (111). Both the spreadsheet program (1136) and the spreadsheet data file 134) may be resident in a memory (117) of the computer system (110) at runtime.

FIG. 2 shows a representation of the user interface (111) before, during and after a query in accordance with an embodiment of the invention. A user interface (111) may include two sections: a spreadsheet (201) and a command window (202). The spreadsheet section (210) comprises the traditional grid structure in which rows and columns of data may be presented and manipulated by the user, while the command window (202) may allow the spreadsheet program (136) to provide the user with additional information and functionality for interacting with the data.

Prior to a query being executed in this embodiment, the spreadsheet section (201A) of the user interface (111A) includes empty fields (211A, 212A, 213A, 214A) and a command window (202A) presenting the user with a login button (221). Upon pressing the login button (221) and providing login information, if authenticated the user may be presented in the command window (202B) with data from which the user may formulate a query, such as prior queries submitted by the user and a navigation area (e.g., a hierarchical visualization based on particular business processes) within which the user can enter a new query. The command window (202B) may also display a submit query button (222) for the user to press once a query has been selected or entered.

After the query request is submitted to the back-end, the spreadsheet user interface (111B) may then display the data set resulting from the query request in the spreadsheet section (201B). The resulting data set may include, for example, fields for employee names (211B), employee IDs (212B), employee groups (213B), and employee titles (214B), in addition to other data (218) that is based on a role assigned to the user. The spreadsheet data file 134 may also contain hidden data (219), or metadata, that is not displayed by the spreadsheet program (136) that is used to track the changes in the data and map the spreadsheet entries with the original data set in the back-end.

The command window (202C) may also present the user with buttons to refresh the spreadsheet data with the current back-end data set values (231), to upload modified spreadsheet data values into the back-end (232), and to store the current spreadsheet layout (e.g., the arrangement/formatting of columns) as a template for a future spreadsheet (233).

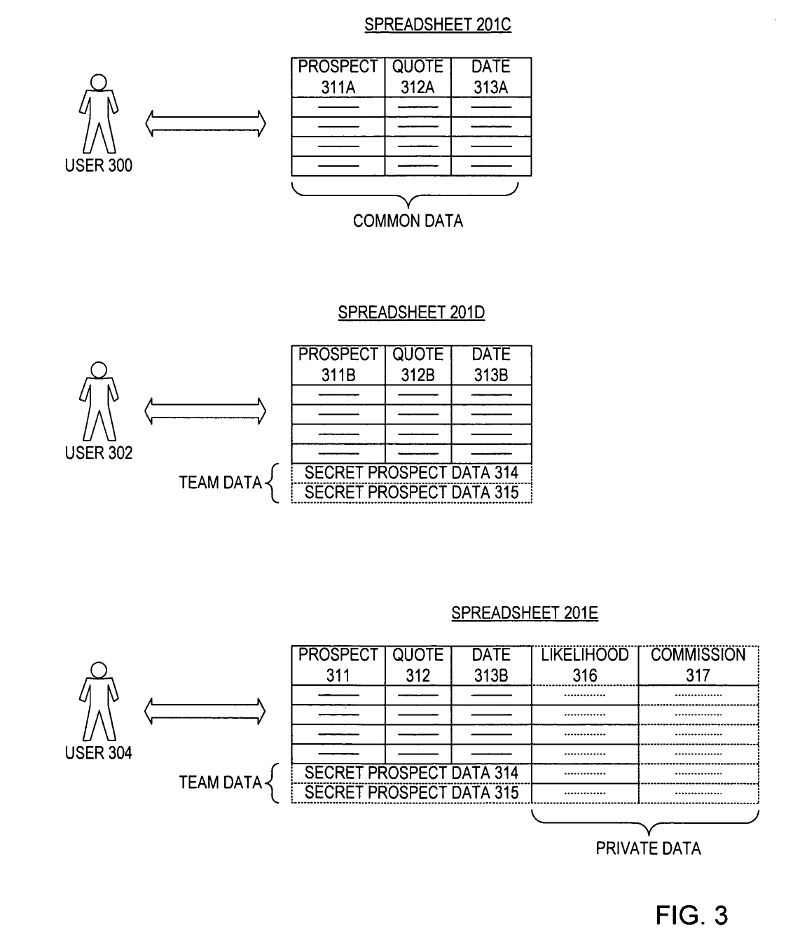

FIG. 3 depicts how the same query may result in a different view of the data set based on the role assigned to the user submitting the query. For example, spreadsheet 201C shows the results of a query by user 300 for business proposals stored in the back-end. Since no role is assigned to user 300 in the back-end, user 300 only has general authority to access common data which is retrieved and displayed under the fields for prospect (311A), quote (312A) and date (313A).

However, user 302 is assigned to a team role in the back-end, and thus has the authority to access the common data and team data, which may include information on prospects that are only known to user 302's work team and which the work team may wish to keep secret from anyone else in the company. Thus, in response to the same query on business proposals, spreadsheet 201D displays the secret team data (314 and 315) in addition to the common data.

Lastly, user 304 is assigned to a private role and a team role in the back-end, and thus has the authority to access the common data, team data, and private data which may include user 304's personal assessment of how likely each proposal is to succeed and how much commission would be generated. Thus, in response to the same query on business proposals, spreadsheet 201E displays the private data (fields 316 and 317) in addition to the common data and team data.

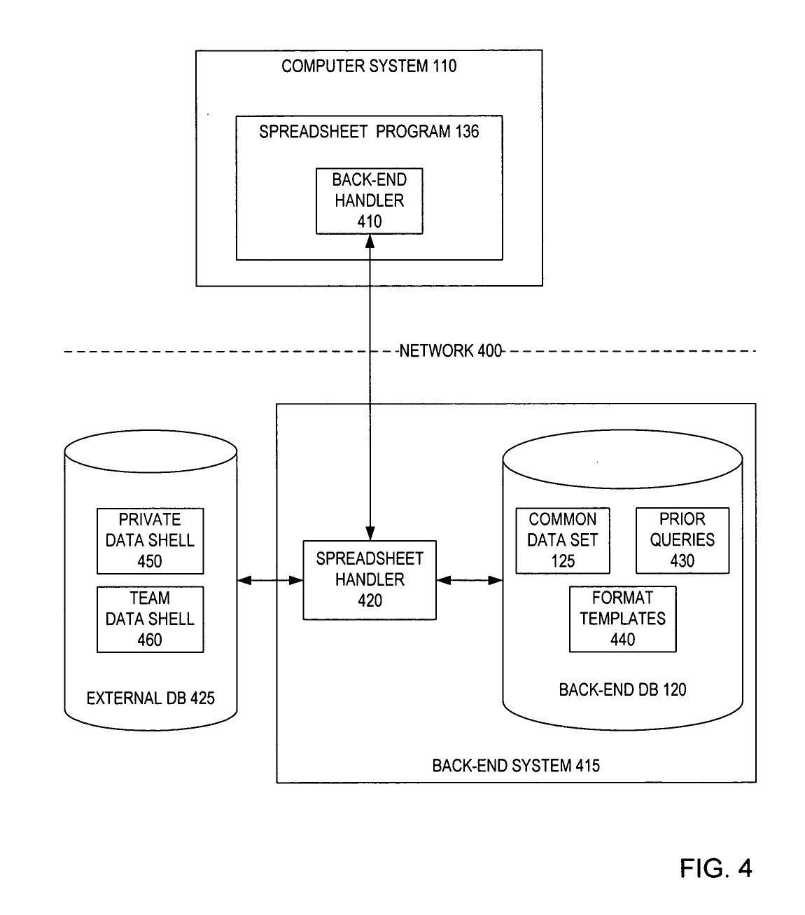

FIG. 4 depicts a system architecture that supports embodiments of the present invention. The spreadsheet program (136) running on the user computer system (110) may include a back-end handler module (410) that provides the front-end functionality of the present invention such as, for example, communicating requests across a network (400) to the back-end system (415) and providing a presentation layer for login and data operations. The back-end handler module (410) may comprise, for example, an extension to a known spreadsheet application, such as a DLL for Microsoft Excel®. The back-end system (415), which may also be considered a data server, may include a spreadsheet handler (420) that provides the back-end functionality of the present invention such as, for example, responding to requests from the computer system (110) and back-end data management with a back-end database (120) and an external database (425).

The back-end database (120) may include a common data set (125) to be queried by the spreadsheet user, a list of prior queries associated with each user (430) from which the user may formulate a new query, and spreadsheet format templates (440) that may be used to provide a pre-defined layout in the spreadsheet for the display of queried data. The external database (425) may include extensions to the common data set (125) organized by roles assigned to users. For example, a private data shell (450) may include private data extensions of individual users, and a team data shell (460) may include data extensions pertaining to organizational groupings of users.

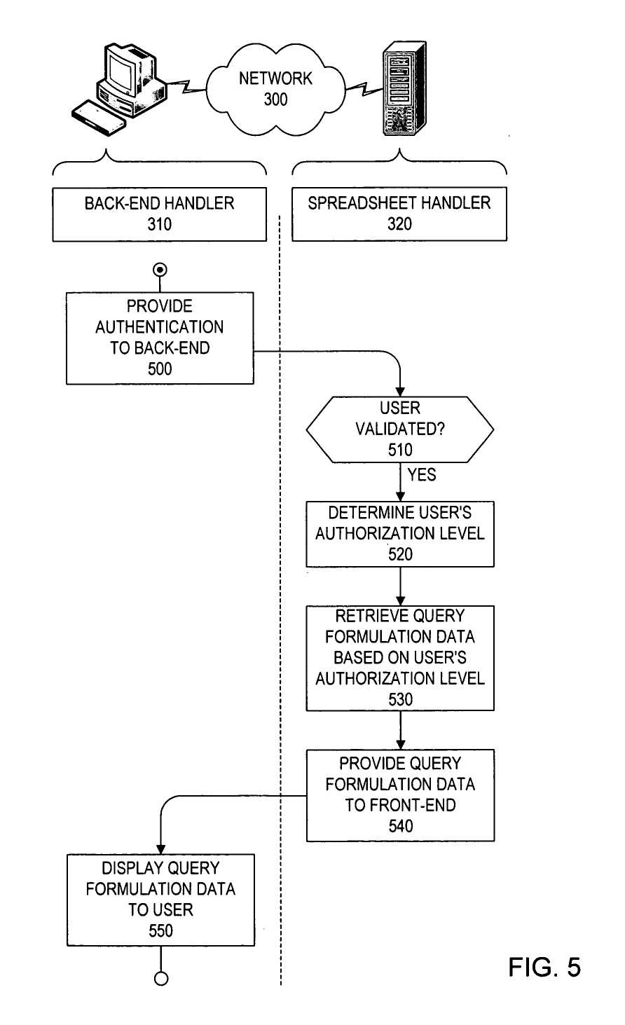

FIG. 5 depicts an authentication and query presentation process in accordance with an embodiment of the present invention. When a user wishes to retrieve data from the back-end system (415) to be imported into a spreadsheet, the user may press a login button (221) in a command window (202A) of the spreadsheet program (136), which may invoke a prompt for login information from the user such as a username and password. Once the back-end handler (410) receives the login request information from the user, it provides the information to the spreadsheet handler (420) for authentication (step 500). (Other authentication mechanisms, such as a single sign-on protocol, for example, may also be utilized in embodiments of the present invention.) Once the spreadsheet handler (420) receives the authentication information, it determines if the user is allowed to access the back-end system (415) (step 510), and if so, determines an authorization level associated with the user (step 520). Upon making this determination, it retrieves query formulation data in accordance with the user's authentication level (step 530). The spreadsheet handler (420) then provides the retrieved query formulation data to the back-end handler (410) (step 540), which displays the query formulation data to the user in the command window (202B) (step 550).

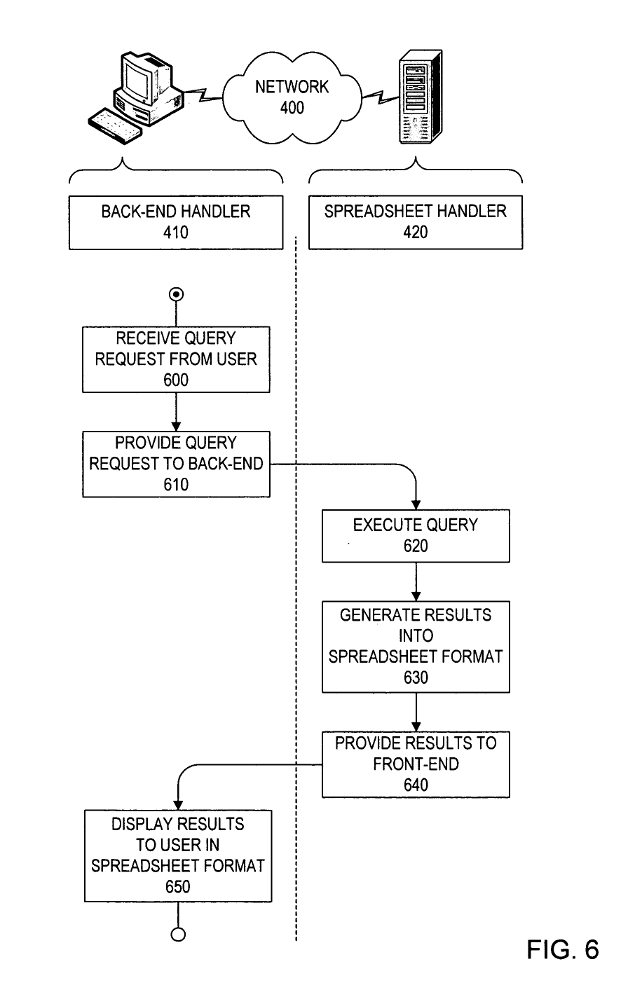

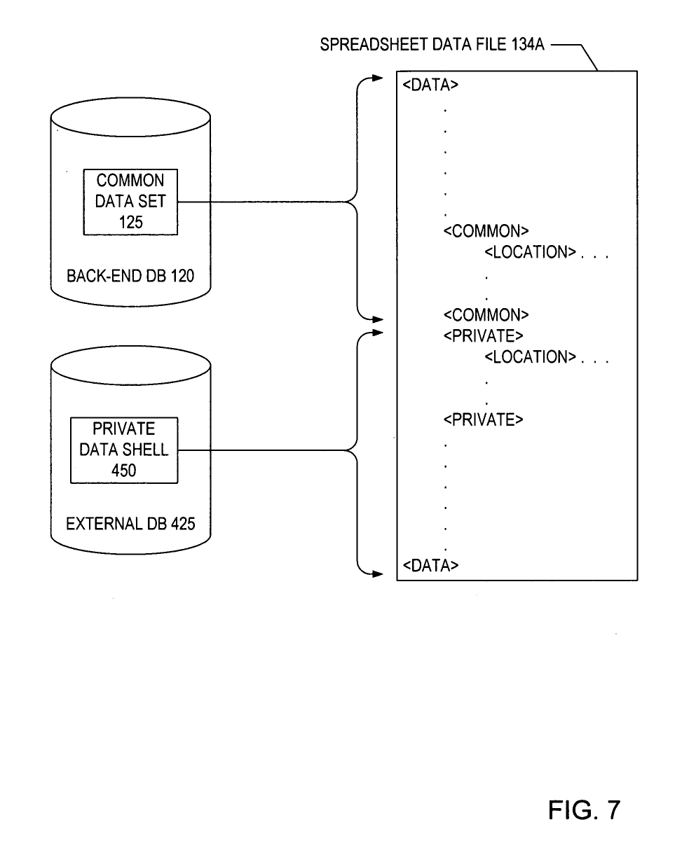

FIG. 6 depicts a subsequent query process in accordance with an embodiment of the present invention. Once the back-end handler (410) receives the query request from the user (e.g., a query selected or entered by the user in the command window (202B)) (step 600), it provides the query request to the spreadsheet handler (420) (step 610), which then executes the query at the back-end database (120) and, if a role is assigned to the user, at the external database (425) (step 620). The spreadsheet handler (420) then generates the resulting data set or sets into a format recognizable by the spreadsheet program (136) (step 630) as shown in FIG. 7, for example. The resulting spreadsheet data file (134) is then provided to the back-end handler (410) (step 640) for display to the user (step 650) through the spreadsheet user interface (111B).

FIG. 7 depicts the generation of query results from the back-end database (120) and the external database (425) into a spreadsheet data file (134A) in accordance with an embodiment of the present invention. Once the spreadsheet handler (420) receives the data sets resulting from the executed queries, it may generate an XML schema definition for the resulting data elements and an XML data structure to hold the resulting data elements. A pre-defined style sheet, tailored to an import format for the particular type of spreadsheet program (136) used by the user, may be merged with the schema definition via an XSL transformation to create a resulting style sheet, which then may be merged with the XML data structure via another XSL transformation to create the final spreadsheet data file (134A) (e.g., in the SpreadsheetML format).

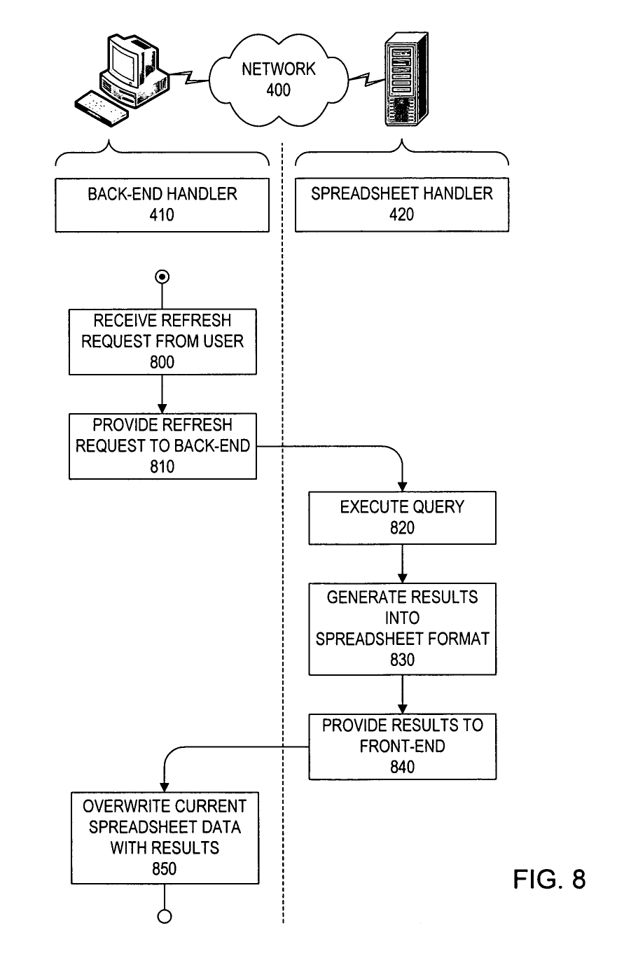

FIG. 8 depicts a refresh process in accordance with an embodiment of the present invention. This process is similar to the query process of FIG. 6, in that the back-end handler (410) asks the spreadsheet handler (420) to perform an updated query so that any values in the resulting data set that have changed since the prior query was executed can be reflected in the user's spreadsheet.

Once the back-end handler (410) receives the refresh request from the user (step 800), it provides the refresh request to the spreadsheet handler (420) (step 810), which then executes the same query as before at the back-end database (120) and, if a role is assigned to the user, at the external database (425) (step 820). (The refresh request to the spreadsheet handler (420) may comprise either the actual prior query request, or simply an instruction for the spreadsheet handler (420) to execute the prior query request associated with the user stored in the prior queries table (430) of the back-end database (120)). The spreadsheet handler (420) then generates the resulting data set or sets into a format recognizable by the spreadsheet program (136) (step 830) as shown in FIG. 7, for example. The resulting spreadsheet data file (134) is then provided to the back-end handler (410) (step 840) for display to the user (step 850) through the spreadsheet user interface (111B). The back-end handler (410) will overwrite any outdated data values in the spreadsheet with the corresponding updated values from the back-end database (120).

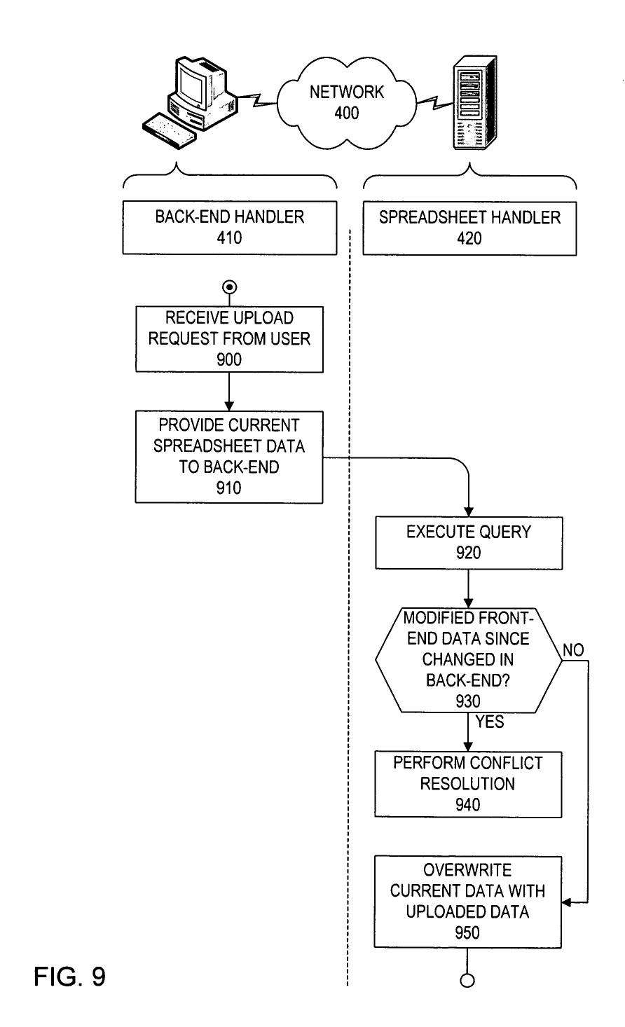

FIG. 9 depicts an upload process in accordance with an embodiment of the present invention. Upon receiving an upload request from the user (step 900), the back-end handler (410) provides the upload request to the spreadsheet handler (420) (step 910), which then executes the query associated with the uploaded data at the back-end database (120) and, if a role is assigned to the user, at the external database (425) (step 920). If the spreadsheet handler (420) determines that any of the back-end data corresponding to any modified uploaded data has changed since the back-end data was last provided to the back-end handler (410) (step 930), then a conflict exists (because the user has changed a value at the front-end while someone else has changed the corresponding value at the back-end) and a conflict resolution process is initiated (step 940). If the spreadsheet handler (420) determines that no back-end data corresponding to any modified uploaded data has changed since the back-end data was last provided to the back-end handler (410), then the back-end data is overwritten with the modified uploaded data (step 950).

The determination in step 930 may be made if the spreadsheet data file (134) includes the last version of data provided by the spreadsheet handler (420) as hidden data (219) in addition to the local version that is modified by the user at computer system 110. If these two version of the data are provided to the spreadsheet handler (420) with an upload request (step 910), then the spreadsheet handler (420) may compare the results of the query or queries executed in step 920 with the last hidden version of data to determine whether any changes have occurred for corresponding data values both at the front-end and back-end. Also, if no conflict exists, the spreadsheet handler (420) may determine which values to update in step 950 by comparing the local version of the data with the last version.

In the event a conflict does exist (step 940), the spreadsheet handler (420) may institute a conflict resolution process that allows the user to view, in a line item manner for each conflicting value, both the front-end data value modified by the user and the corresponding back-end data value modified by someone else to determine which value is to be persisted in the back-end. This process may be implemented via a split screen window on computer system 110 or via the spreadsheet UI (111).

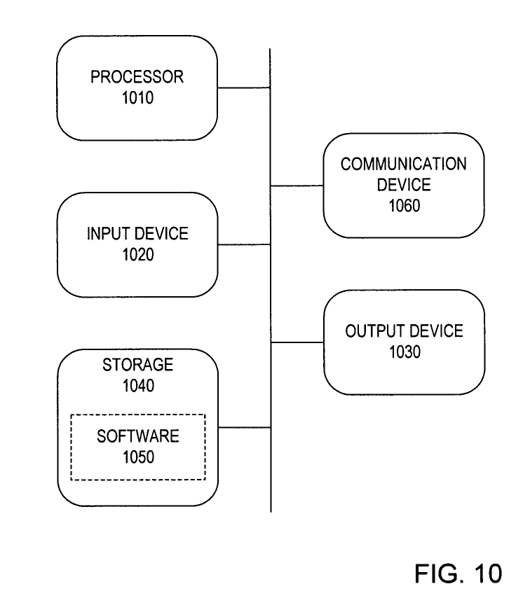

FIG. 10 illustrates the components of a basic computing device in accordance with an embodiment of the present invention, which may include computer system 110 and back-end system 415. The computing device may be a personal computer, workstation, handheld personal digital assistant (“PDA”), server, or any other type of microprocessor-based device. The computing device may include one or more of processor 1010, input device 1020, output device 1030, storage 1040, and communication device 1060.

Input device 1020 may include a keyboard, mouse, pen-operated touch screen or monitor, voice-recognition device, or any other device that provides input. Output device 1030 may include a monitor, printer, disk drive, speakers, or any other device that provides output.

Storage 1040 may include volatile and nonvolatile data storage, including one or more electrical, magnetic or optical memories such as a RAM, cache, hard drive, CD-ROM drive, tape drive or removable storage disk. Communication device 1060 may include a modem, network interface card, or any other device capable of transmitting and receiving signals over a network. The components of the computing device may be connected via an electrical bus or wirelessly.

Software 1050, which may be stored in storage 1040 and executed by processor 1010, may include, for example, the application programming that embodies the functionality of the present invention (e.g., as embodied in back-end handler 410 and spreadsheet handler 420). Software 1050 may include a combination of enterprise servers such as an application server and a database server.

Network 400 may include any type of interconnected communication system, which may implement any communications protocol, which may be secured by any security protocol. The corresponding network links may include telephone lines, DSL, cable networks, T1 or T3 lines, wireless network connections, or any other arrangement that implements the transmission and reception of network signals.

The computing device may implement any operating system, such as Windows or UNIX. Software 1050 may be written in any programming language, such as ABAP, C, C++, Java or Visual Basic. In various embodiments, application software embodying the functionality of the present invention may be deployed on a standalone machine, in a client/server arrangement or through a Web browser as a Web-based application or Web service, for example.

Several embodiments of the invention are specifically illustrated and/or described herein. However, it will be appreciated that modifications and variations of the invention are covered by the above teachings and within the purview of the appended claims without departing from the spirit and intended scope of the invention. For example, software modules that implement the present invention such as back-end handler 410 and spreadsheet handler 420 may comprise several discrete modules that together still provide the same functionality, data specified in back-end database 120 and external database 425 may be resident in one database and/or system or spread over several databases and/or systems, and the flow diagrams of FIGS. 5, 6, 8 and 9 may encompass several intermediate steps that do not detract from the higher level functionality described therein.

What is claimed is:

1. A computer-implemented method for integrating role-based data into a spreadsheet, comprising:
receiving a query request from a spreadsheet application on behalf of a user of the spreadsheet application;
determining a role assigned to the user;
executing a first query associated with the query request and not constrained by the role assigned to the user;
executing a second query associated with the query request and constrained by the role assigned to the user;
combining results of the first and second executed queries to form a first data set; and
providing to the spreadsheet application the first data set in response to the query request.

2. The method of claim 1, wherein the first query is executed on a different database than that on which the second query is executed.

3. The method of claim 1, wherein the first data set is converted into a format based on XML that is recognizable by the spreadsheet program.

4. The method of claim 1, further comprising:
receiving from the spreadsheet application a request to refresh the first data set;
executing one or more queries associated with the refresh request; and
providing to the spreadsheet application a second data set as a result of the one or more executed queries, the second data set being an updated version of the first data set.

5. The method of claim 1, further comprising:
receiving from the spreadsheet application a request to upload modified portions of the first data set along with current spreadsheet data.

6. The method of claim 5, wherein the current spreadsheet data includes the first data set along with a current data set including the modified portions of the first data set.

7. The method of claim 5, further comprising:
determining whether a local version of any of the modified portions of the first data set have been changed since the first data set was provided to the spreadsheet application.

8. The method of claim 7, further comprising:
if a local version of any one of the modified portions of the first data set is determined not to have been changed since the first data set was provided to the spreadsheet application, storing the any one of the modified portions of the first data set.

9. The method of claim 7, further comprising:
if a local version of any one of the modified portions of the first data set is determined to have been changed since the first data set was provided to the spreadsheet application, initiating a conflict resolution process to resolve which version of the any one of the modified portions of the first data set should be stored.

10. A computer-implemented method for integrating role-based data into a spreadsheet, comprising:
providing authentication information to a data server by a spreadsheet application, the authentication information pertaining to a user of the spreadsheet application;
receiving query formulation data from the data server upon approval of the authentication information, the query formulation data provided in accordance with an authorization level determined by the data server to be assigned to the user;
displaying the query formulation data via a spreadsheet application user interface provided by the spreadsheet application;
receiving a query request from the user based on the query formulation data;
providing the query request to the data server;
receiving a first data set as a result of the query request from the data server, the first data set including a first portion associated with a role assigned to the user at the data server and a second portion not associated with the assigned role; and
displaying the first data set in a spreadsheet via the spreadsheet application user interface.

11. The method of claim 10, wherein the authentication information is derived from a login request entered by the user via the spreadsheet application user interface, the login request including a username and password.

12. The method of claim 10, wherein the query formulation data includes previous queries associated with the user at the data server.

13. The method of claim 10, wherein the query formulation data includes navigation data for constructing a query, the navigation data including identifiers corresponding to database fields controlled by the data server.

14. The method of claim 10, wherein the query request includes an identification of one of the previous queries associated with the user at the data server.

15. The method of claim 13, wherein the query request includes a query constructed by the user based on the navigation data.

16. The method of claim 10, further comprising:
receiving a request from the user to refresh the first data set;
providing the refresh request to the data server;
receiving from the data server a second data set as a result of the refresh request, the second data set being an updated version of the first data set; and
displaying the updated version of the first data set in the spreadsheet via the spreadsheet application user interface.

17. The method of claim 16, wherein the refresh request includes the query request.

18. The method of claim 16, wherein the refresh request includes an instruction for the data server to execute the query request.

19. The method of claim 10, further comprising:
receiving a request from the user to upload modified portions of the first data set to the data server; and
providing current spreadsheet data to the data server.

20. The method of claim 19, wherein the current spreadsheet data includes the first data set along with a current data set including the modified portions of the first data set.
